(19) United States
(12) Patent Application Publication
(10) Pub. No.: US 2011/0143834 A1
(43) Pub. Date: Jun. 16, 2011

(54) LOCATION-BASED CUSTOMIZATION OF AVATARS IN GAMING SYSTEMS

(75) Inventors: Andrew C. Guinn, Chicago, IL (US); Damon E. Gura, Chicago, IL (US); Jeremy M. Hornik, Chicago, IL (US)

(73) Assignee: WMS Gaming, Inc., Waukegan, IL (US)

(21) Appl. No.: 12/968,269

(22) Filed: Dec. 14, 2010

Related U.S. Application Data
(60) Provisional application No. 61/286,465, filed on Dec. 15, 2009.

(51) Int. Cl. G06F 17/00

(52) U.S. Cl. 463/25; 463/42; 463/43

(57) ABSTRACT

A wagering game system and its operations are described herein. In some embodiments, the operations can include determining that a wagering game session for a wagering game is initiated at a first gaming location. The wagering game comprises an avatar that is customizable according to a plurality of location-based customization options. The operations can also include configuring the wagering game with a first set of customization options, associated with the first gaming location, for the avatar of the wagering game to be played on a first gaming machine associated with the first gaming location. The operations can further include determining that a wagering game session for the wagering game is initiated at a second gaming location, and configuring the wagering game with a second set of customization options, associated with the second gaming location, for the avatar of the wagering game to be played on a second gaming machine.

### RELATED APPLICATIONS

This application claims the priority benefit of U.S. Provisional Application Ser. No. 61/286,465 filed Dec. 15, 2009.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2010, WMS Gaming, Inc.

### FIELD

Embodiments of the inventive subject matter relate generally to wagering game systems, and more particularly to location-based customization of avatars in wagering game systems.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

Traditionally, wagering game machines have been confined to physical buildings, like casinos (e.g., major casinos, road-side casinos, etc.). The casinos are located in specific geographic locations that are authorized to present wagering games to casino patrons. However, with the proliferation of interest and use of the Internet, some wagering game manufacturers have recognized that a global public network, such as the Internet, can reach to various locations of the world that have been authorized to present wagering games. Consequently, some wagering game manufacturers have created wagering games that can be processed by personal computing devices and offered via online casino websites (“online casinos”).

### BRIEF DESCRIPTION OF THE FIGURES

Embodiments are illustrated in the Figures of the accompanying drawings in which:

FIG. 1 is a conceptual diagram illustrating an example of implementing location-based customization of avatars associated with wagering games in a wagering game system, according to some embodiments;

FIG. 2 is a conceptual diagram that illustrates an example of a wagering game system architecture, according to some embodiments;

FIG. 3 is a flow diagram illustrating operations for implementing location-based customization of avatars associated with wagering games in a wagering game system, according to some embodiments;

FIG. 4 is a flow diagram illustrating additional operations for implementing location-based customization of avatars associated with wagering games in a wagering game system, according to some embodiments;

FIG. 5 is a flow diagram illustrating operations for implementing location-based customization of avatars associated with wagering games for community gaming applications, according to some embodiments;

FIG. 6 is a conceptual diagram that illustrates an example of a wagering game machine architecture, according to some embodiments; and

FIG. 7 is a perspective view of a wagering game machine, according to example embodiments.

### DESCRIPTION OF THE EMBODIMENTS

This description of the embodiments is divided into five sections. The first section provides an introduction to some embodiments, while the second section describes example wagering game machine architectures. The third section describes example operations performed by some embodiments and the fourth section describes example wagering game machines in more detail. The fifth section presents some general comments.

### Introduction

This section provides an introduction to some embodiments.

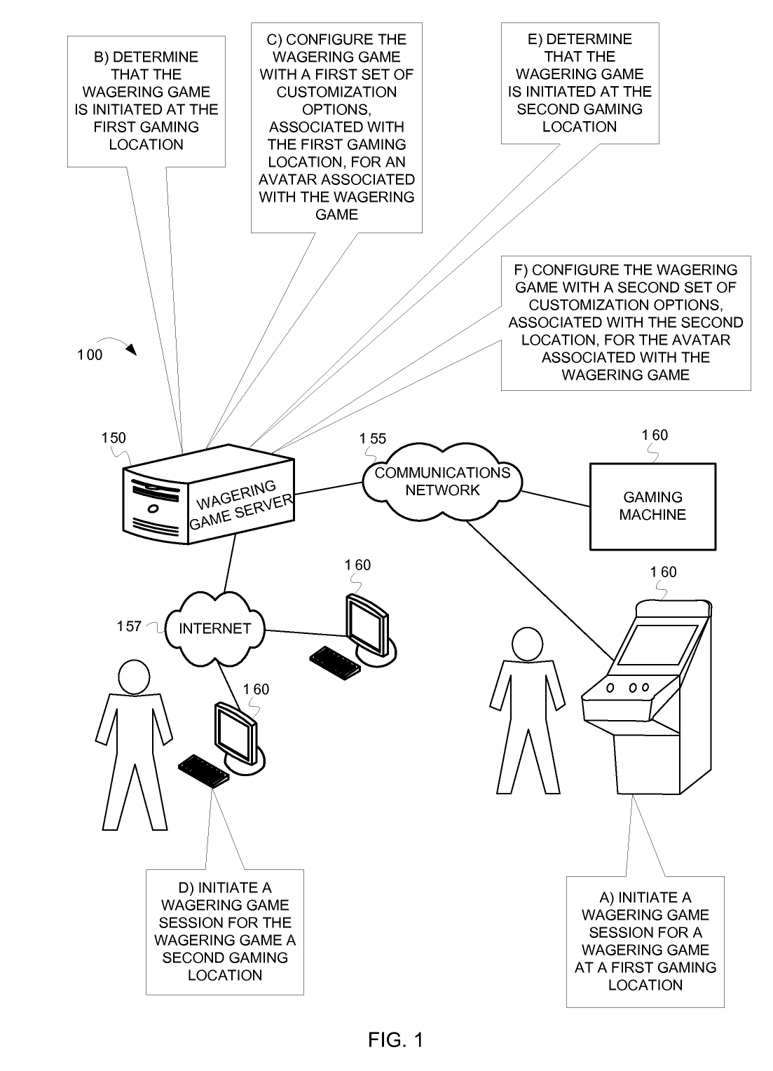

Wagering game systems offer wagering game players (“players”) entertainment value and the opportunity to win monetary value. Wagering game systems can try to enhance the gaming experience by offering players wagering games that incorporate customizable avatars. In some embodiments, the wagering game system can offer players location-based customization options for the avatars associated with the wagering games. In other words, the available customization options for the avatars can vary based on different gaming location where players play the wagering games, as will be further described below with reference to FIGS. 1-5. In one example, a first player can play a wagering game that incorporates an avatar at a first gaming location (e.g., a first casino), and a second player can play the same wagering game incorporating the avatar at a second gaming location (e.g., a second casino). In this example, the wagering game system can provide the first player one set of customization options for the avatar associated with the wagering game being played at the first gaming location, and provide the second player a different set of customization options for the avatar associated with the wagering game being played at the second gaming location.

In some embodiments, the location-based customization options for an avatar associated with a wagering game can include the type of avatar (e.g., human, animal, object, etc.), the themes for the avatar (e.g., medieval, pirate, western, space, ocean, movie, sports, etc.), the types of accessories or supplementary items available for customizing the avatar (e.g., hats, shirts, pants, shoes, sunglasses, swords, guns, wings, shields, helmets, etc.), and the themes for the accessories or supplementary items available for customizing the avatar (e.g., medieval, pirate, western, space, ocean, movie, sports, etc.). For instance, in one example, a first set of customization options associated with a first gaming location can include a dragon avatar with a medieval theme, and a second set of customization options associated with a second gaming location can include a human-like avatar with a western theme. In this example, the accessories available to further customize the dragon avatar may incorporate the same medieval theme, and may include hats, shirts, pants, wings, shields, claws, tails, teeth, swords, helmets, and dragon breath type. The accessories available to further customize the human-like avatar may incorporate the same western theme, and may include hats, shirts, pants, boots, guns, battle moves, horses, and wagons. In another example, for the second gaming location, the avatar associated with the wagering game may be the same as the first gaming location (e.g., a dragon avatar with a medieval theme), but the accessories or supplementary items available to further customize the avatar may be different in the second gaming location than in the first gaming location. Additionally, besides changing the appearance of the avatar, some of the accessories or supplementary items available as location-based customization options for the avatar can enhance or optimize certain attributes of the avatar and the game, or provide other benefits for the player. For instance, in the dragon avatar example described above, different types of wings, swords, and dragon breath can be made available (e.g., earned by the player depending on the player's game performance, depending on coin-in, depending on time played, etc.) to customize the avatar. These avatar accessories can enhance or optimize some aspect of the game play for the player, or reward the player. In some embodiments, the manner in which the avatar and game is enhanced or optimized may be dependent on the gaming location. For example, upgraded wings or dragon breath may allow the dragon avatar to win more points or credits for the player in a bonus game in some gaming locations, or may act as a multiplier for the base game in some gaming locations, or may reward the player extra spins of the base game in other gaming locations. Furthermore, the location-based customization options for the avatar can include location-based use restrictions for one or more of the accessory or supplementary items available for customizing the avatar. For instance, in the dragon avatar example described above, the player may earn a pair of upgraded wings for the dragon avatar at a first gaming location (e.g., a physical casino) that only enhances or optimizes the game play when the player plays the wagering game at a second gaming location (e.g., an online casino). In this example, the wagering game system can store the avatar and the customization items the player has selected/earned (e.g., upgraded wings for the dragon avatar) at the first gaming location, and use the same avatar and the stored customization items to play the wagering game at the second gaming location.

In some embodiments, different gaming locations can be different physical casinos (i.e., brick-and-mortar casinos), different online casinos, other locations offering wagering games (e.g., wagering games at airports or bars), and different geographic locations (e.g., cities, states, countries, etc.) where players play wagering games remotely via the Internet. The different physical casinos can be different physical casinos in the same geographic area (e.g., different physical casinos in Las Vegas), and different physical casinos in different geographic areas (e.g., different physical casinos in different cities, states, and countries). The different online casinos can be different websites that incorporate online casinos. In some examples, the different gaming locations can be different rooms or sections of the same physical casino. For example, different customizations options for avatars of wagering games can be made available for high betting (e.g., “high roller”) sections of a physical casino compared to other sections of the same physical casino. In other examples, different customization options can be provided for different gaming platforms or clients used to play wagering games (e.g., in-casino wagering game machines, personal computers, mobile phones, etc.). Furthermore, in some examples, some gaming locations can be gaming-related locations. For example, different customization options for avatars can be provided for websites that cater to casino gaming players, even though the websites may not offer casino games.

In some embodiments, each of wagering games that offer players location-based customization options for the avatars associated with the wagering games may include a base (or “primary”) wagering game and one or more associated secondary wagering games. A base wagering game may include the main wagering games that players play for entertainment and the opportunity to win monetary awards, e.g., slots, video poker, video blackjack, video roulette, etc. The base wagering game may be associated with one or more secondary games that complement or supplement the wagering game (e.g., triggered by certain game events in the base game), provide additional entertainment value, and also offer players additional opportunities to win monetary or non-monetary awards. Each wagering game can incorporate the avatar, customizable according to various location-based customization options, into a wagering game session in various ways. In some embodiments, the base wagering game can display the avatar while the player plays the base wagering game, and otherwise incorporate the avatar into the primary wagering game. For example, in the dragon avatar example, the dragon avatar can interact with the various game elements associated with the base wagering game (e.g., interact with the reels), the dragon avatar can be a visual indicator of the player's performance in the base wagering game (e.g., the more the avatar is customized with various accessories the better the player is doing), and the dragon avatar can join the audio/video presentations of various game events (e.g., join the celebration of a big win). In some embodiments, the avatar can be incorporated as part of both the base wagering game and one or more associated secondary wagering games. For example, in addition to the participation in the base wagering game, the dragon avatar can be a visual indicator that a secondary wagering game has been triggered by a game event in the base game, and the dragon avatar can be incorporated into the secondary game as the main game element of the secondary game (e.g., in a picking bonus game, the player would use the dragon avatar to make selections, and in a fighting side game, the dragon avatar would participate in the fight using some or all of the avatar accessories and other customization items). Also, the dragon avatar can be incorporated into the presentation when the player wins monetary or non-monetary awards in the secondary wagering game (e.g., the dragon avatar can reward the player with non-monetary credits, and increase the credit balance with the dragon's breath).

FIG. 1 is a conceptual diagram illustrating an example of implementing location-based customization of avatars associated with wagering games in a wagering game system, according to some embodiments. In the example shown in FIG. 1, the wagering game system (“system”) 100 includes a wagering game server 150 connected to a plurality of wagering game machines (“gaming machines”) 160 via a communications network 155. The wagering game server 150 may also be connected to a plurality of gaming machines 160 via the Internet 157.

At stage A, a wagering game session for a wagering game is initiated at a first gaming location. For example, a gaming machine 160 at a first physical casino initiates the wagering game session in response to detecting an input from a player indicating the player wants to play the wagering game. The wagering game comprises an avatar that is customizable according to a plurality of location-based customization options. In one example, the wagering game can be a slots wagering game including one or more secondary wagering games (e.g., bonus games, side games, etc.).

At stage B, the wagering game server 150 determines that the wagering game session for the wagering game has been initiated at the first gaming location. For example, the wagering game server 150 can receive an indication from the gaming machine 160 associated with the first gaming location that the wagering game session for the wagering game has been initiated and also provide location information.

At stage C, the wagering game server 150 configures the wagering game with a first set of customization options, associated with the first gaming location, for the avatar associated with the wagering game. The wagering game server 150 may also cause the gaming machine 160 to present the wagering game configured with the first set of customization options. For example, the wagering game server 150 may cause the gaming machine 160 at a first physical casino to present the wagering game on a main display and on a top display of the gaming machine 160. It is noted that the same wagering game can be configurable with different customization options for the avatar at different gaming locations, as will be further described below.

In some embodiments, the wagering game server 150 can configure the wagering game with the location-based customization options (e.g., the first set of customization options) by configuring various game play elements associated with the wagering games; for example, configuring game play elements, such as executable game code, lookup tables, configuration files, audio or visual representations of the game, game assets, or the like. In one example, the wagering game server 150 can configure the wagering game such that the wagering game elements, environment, and game interface displayed to the player exhibits the theme specified by the configuration options associated with the particular gaming location. The wagering game server 150 can configure the wagering game such that the accessories and supplementary items available for further customizing the avatar exhibit the theme and other characteristics (e.g., special powers, enhancements, use restrictions, etc.) specified by the associated customization options. For example, this may configure the avatar accessories and supplementary items that are found within the wagering game, that are earned by playing the wagering game, and/or that are included in an avatar customization menu or window (e.g., a “build your avatar” or “customize your avatar” window) to be consistent with the specifications of the associated customization options. It is noted, however, that the wagering game server 150 may configure other aspects of the wagering game to be consistent with the customization options for the avatar; e.g., the wagering game server 150 can configure video and audio presentations of the avatar that will be displayed during celebrations of a win (or other game events) to be consistent with the theme and other characteristics specified by the customization options.

At stage D, a wagering game session for a wagering game is initiated at a second gaming location. For example, an online wagering game server that hosts and manages a first online casino can initiate the wagering game session in response to detecting an input from a player indicating the player wants to play the wagering game online via a gaming machine 160. In this example, the same wagering game comprising the avatar that is customizable according to a plurality of location-based customization options, which was initiated at the first physical casino, is initiated at the first online casino.

At stage E, the wagering game server 150 determines that the wagering game session for the wagering game has been initiated at the second gaming location. For example, the wagering game server 150 can receive an indication from the online wagering game server associated with the second gaming location (e.g., the first online casino) that the wagering game session for the wagering game has been initiated at the second gaming location and provide location information.

At stage F, the wagering game server 150 configures the wagering game with a second set of customization options, associated with the second gaming location, for the avatar associated with the wagering game. In this example, the second set of customization options, associated with the second gaming location, is different than the first set of customization options, associated with the first gaming location. The wagering game server 150 may then cause the online wagering game server to initiate the wagering game in the first online casino and present the wagering game on a main display (e.g., computer monitor) of the gaming machine 160.

For instance, similar to the example described above, the wagering game initiated at the first and second gaming locations may be a wagering game that incorporates a dragon avatar. In one example, the dragon avatar can be shown during the base game (e.g., the dragon avatar can be customizable, and interact with the player, as the player plays a slots base game), and the dragon avatar may be the main game element of a bonus game associated with the base game that is triggered in response to certain events in the base game (e.g., big wins). In one embodiment, the first set of customization options associated with the wagering game at the first gaming location may comprise a different theme than the second set of customization options associated with the wagering game at the second location. For example, at the first gaming location, the dragon avatar and the available avatar accessories or supplementary items may have a medieval theme, and at the second gaming location, the dragon avatar and the available avatar accessories or supplementary items may have a space theme. In another example, if the first gaming location is the Las Vegas Luxor casino, the theme may be an Egyptian theme, and if the second gaming location is the Las Vegas Treasure Island casino, the theme may be a pirate theme. In one embodiment, the theme for the dragon avatar and the available avatar accessories or supplementary items may have the same theme (e.g., a medieval theme) at both the first and second gaming locations, but the available accessories or supplementary items to customize the dragon avatar may vary. For example, as described above, different avatar accessories or supplementary items can be made available at each gaming location, or the available avatar accessories for customizing the dragon avatar may have different enhancement or optimization functions for the wagering game at each gaming location, or the available avatar accessories for customizing the dragon avatar can have different location-based use restrictions associated with the wagering game at each gaming location.

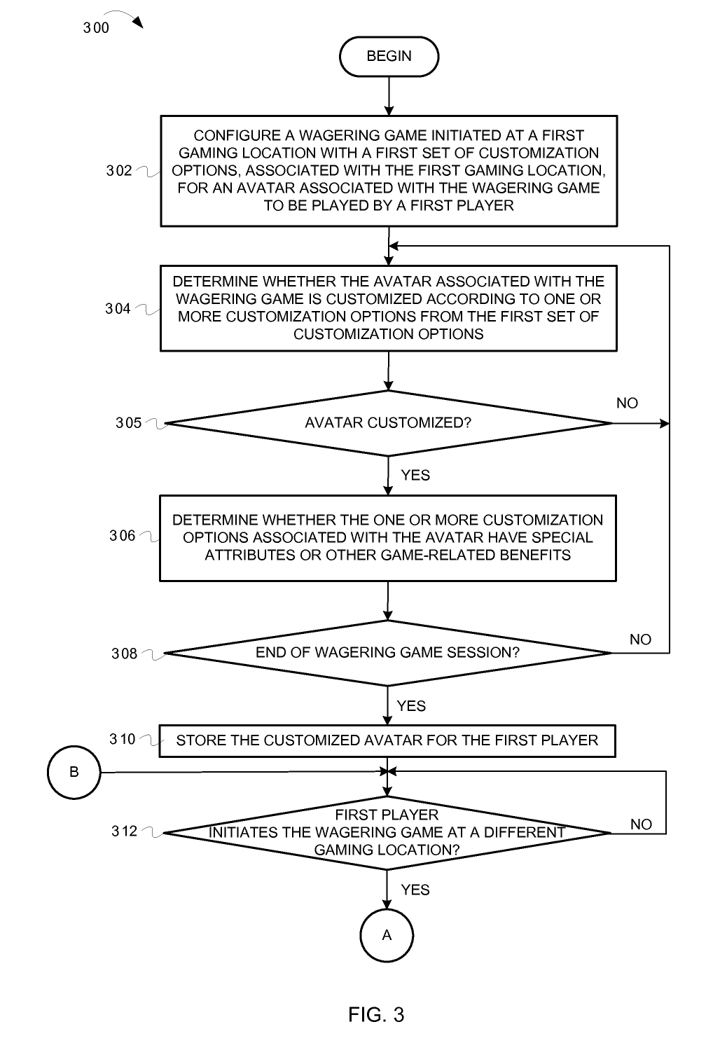

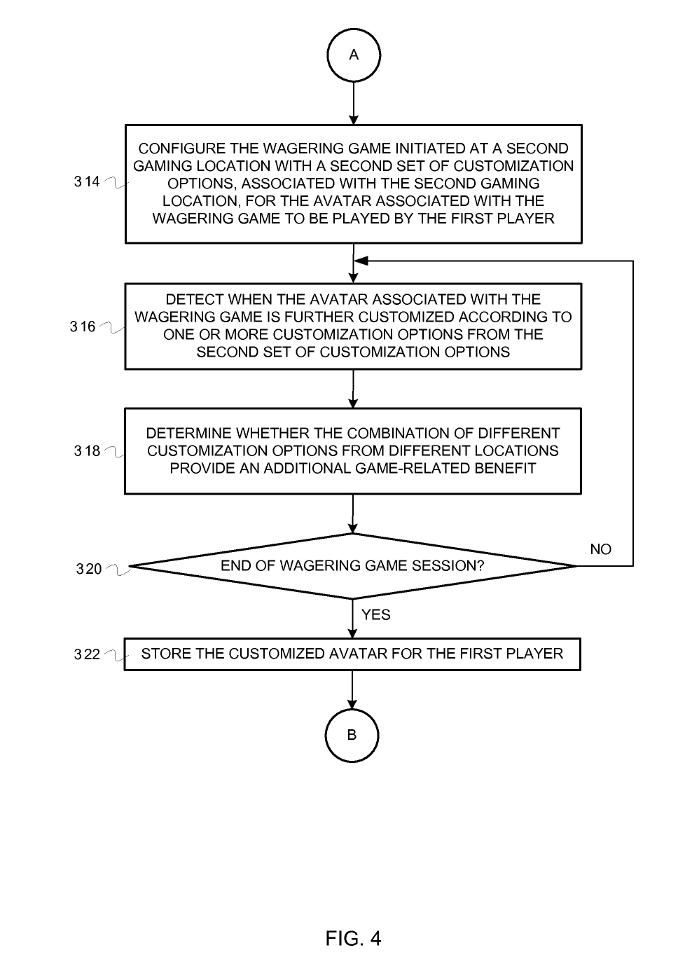

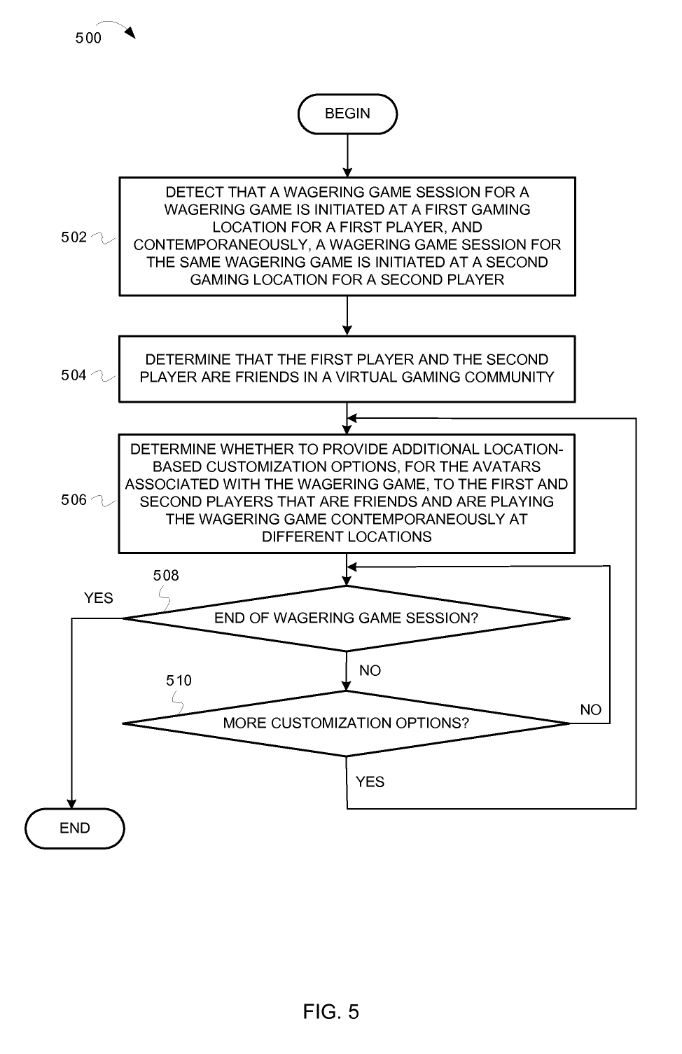

In some embodiments, if a player earns different customization options for an avatar from different gaming locations (e.g., in the dragon avatar example, the player earns a pair of dragon wings from a first gaming location and a dragon tail from a second gaming location), the elements earned at the different gaming locations can combine to provide additional customization options or other game-related benefits (e.g., a dragon sword or a game credit multiplier), as will be further described below with reference to FIGS. 3-4. In some embodiments, the wagering game system can also offer a player additional location-based customization options for the avatar depending on whether the player's friends in a virtual gaming community are contemporaneously playing the wagering game at a different gaming location, as will be further described below with reference to FIG. 5.

Although FIG. 1 describes some embodiments, the following sections describe many other features and embodiments.

### Operating Environment

This section describes example operating environments and networks and presents structural aspects of some embodiments. More specifically, this section includes discussion about wagering game system architectures.

### Wagering Game System Architectures

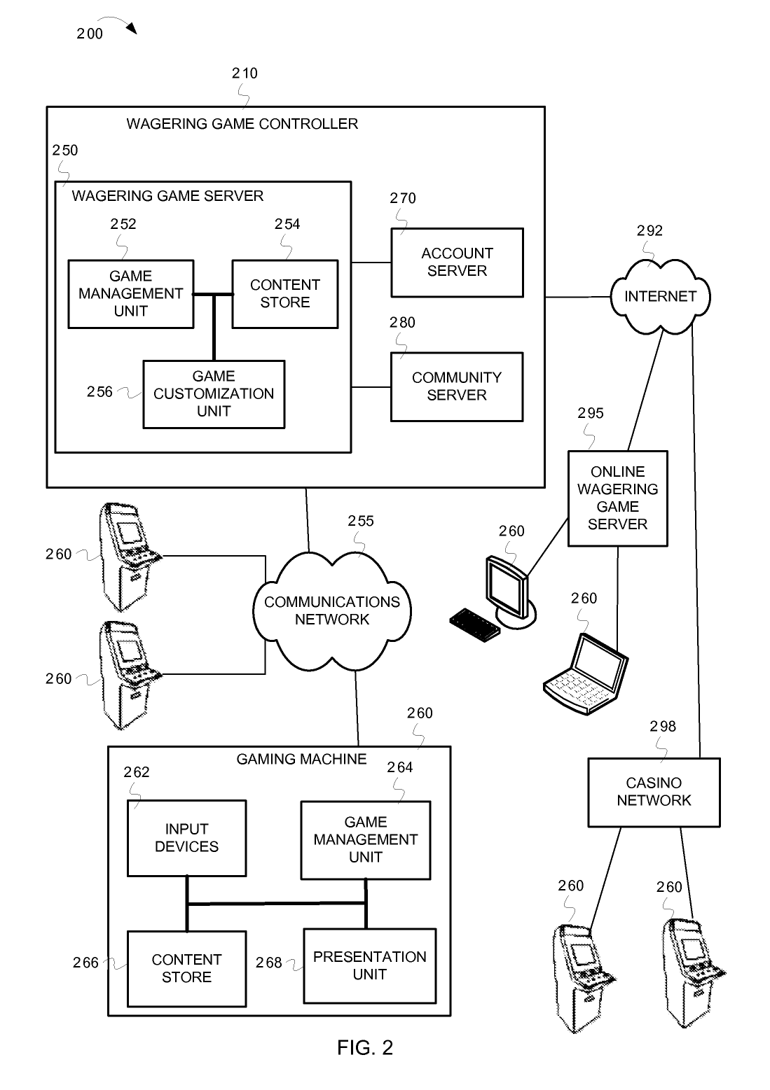

FIG. 2 is a conceptual diagram that illustrates an example of a wagering game system architecture 200, according to some embodiments. As illustrated, the wagering game system architecture 200 includes a wagering game controller 210 and a plurality of gaming machines 260. The wagering game controller 210 is configured to control game content (e.g., game elements, game customization options, game updates, game results, etc.) and communicate game-related information and other information (e.g., social networking services) to and from the plurality of gaming machines 260. In one example, the wagering game controller 210 includes a wagering game server 250, an account server 270, and a community server 280. The wagering game controller 210 may be configured to communicate with other systems, devices, and networks. For example, the wagering game controller 210 may be configured to communication with one or more additional physical casinos (e.g., casino network 298), and/or one or more online wagering game servers that host and manage online casinos (e.g., online wagering game server 295). For example, the wagering game controller 210 can communicate with the casino network 298 and the online wagering game server 295 to obtain location-based information associated with players playing the wagering games at these gaming locations, and to configure the wagering games with location-based customization options for avatars associated with the wagering games.

The wagering game server 250 is configured to manage and control content for presentation on the gaming machines 260. As illustrated, in some embodiments, the wagering game server 250 includes a game management unit 252 configured to provide (e.g., stream) game content and other game-related information to the gaming machines 260. The game management unit 252 is configured to generate (e.g., using a random numbers generator) game results (e.g., win/loss values), including win amounts, for wagering games played on the gaming machines 260. The game management unit 252 can communicate the game results to the gaming machines 260 via the network 255. In some embodiments, the game management unit 252 can also generate random numbers and provide them to the gaming machines 260 so that the gaming machines 260 can generate game results. The wagering game server 250 can also include a content store 254 configured to store content used for presenting wagering games (e.g., base wagering games, secondary bonus games, etc.) and other game-related information associated with wagering game presented on the gaming machines 260. The wagering game server 250 can also include a game customization unit 256 configured to detect location information associated with wagering games, and configure wagering games with location-based customization options for avatars associated with the wagering games, as described herein with reference to FIGS. 1-5.

The account server 270 is configured to control player-related accounts accessible via the wagering game system 200. The account server 270 can manage player financial accounts (e.g., performing funds transfers, deposits, withdrawals, etc.) and player information (e.g., avatars, screen name, account identification numbers, social contacts, financial information, etc.). The account server 270 can also provide auditing capabilities, according to regulatory rules, and track the performance of players, machines, and servers. The account server 270 can include an account controller configured to control information for player accounts. The account server 270 can also include an account store configured to store information for player accounts.

The community server 280 is configured to provide a wide range of services to members of virtual gaming communities. For example, the community servers may allow players to:
Create Social Networks—When creating social networks, members can create electronic associations that inform network members when selected members are: 1) online, 2) performing activities, 3) reaching milestones, 4) etc.
Establish a Reputation—Community members can establish reputations based on feedback from other community members, based on accomplishments in the community, based on who is in their social network, etc.
Provide Content—Community members can provide content by uploading media, designing wagering games, maintaining blogs, etc.
Filter Content—Community members can filter content by rating content, commenting on content, or otherwise distinguishing content.
Interact with Other Members—Community members can interact via newsgroups, e-mail, discussion boards, instant messaging, etc.
Participate in Community Activities—Community members can participate in community activities, such as multi-player games, interactive meetings, discussion groups, real-life meetings, etc.
Connect Casino Players to Online Members—Community members who are playing in casinos can interact with members who are online. For example, online members may be able to: see activities of social contacts in the casino, chat with casino players, participate in community games involving casino players, etc.

In some embodiments, the community server 280 enables online community members (e.g., operating a personal computer (PC) or a mobile device) to participate in and/or monitor wagering games that are being presented in one or more casinos. The community server 280 can enable community members to connect with and track each other. For example, the community server 280 can enable community members to select other members to be part of a social network. The community server 280 can also enable members of a social network to track what other social network members are doing in a virtual gaming community and a real-world casino. For example, in some implementations, the community server 280 assists in enabling members of a social network to see when network members are playing wagering game tables and machines in a casino, accessing a virtual gaming community web site, achieving milestones (e.g., winning large wagers in a casino), etc.

The community server 280 can store and manage content for a virtual gaming community. For example, in some embodiments, the community server 280 can host a web site for a virtual gaming community. Additionally, the community server 280 can enable community members and administrators to add, delete, and/or modify content for virtual gaming communities. For example, the community server 280 can enable community members to post media files, member-designed games, commentaries, etc., all for consumption by members of a virtual gaming community.

The community server 280 can track behavior of community members. In some embodiments, the community server 280 tracks how individuals and/or groups use the services and content available in a virtual gaming community. The community server 280 can analyze member behavior and categorize community members based on their behavior. The community server 280 can configure network components to customize content based on individual and/or group habits.

The community server 280 can manage various promotions offered to members of a virtual gaming community. For example, the promotions community server 280 can distribute promotional material when members achieve certain accomplishments (e.g., scores for online games) in a virtual gaming community. Members may use some of the promotional material when playing wagering games in a casino.

The gaming machines 260 are configured to present wagering games and receive and transmit information to control the content that is presented for the wagering games. The gaming machines 260 can include input devices 262, a wagering game unit 264, a content store 266, and a presentation unit 268. The input devices 262 may include buttons, joysticks, touch screens, cameras, etc., used to detect player input associated with wagering games. The wagering game unit 264 is configured to manage and control the game content that is presented on the gaming machine 260. The wagering game unit 264 can also provide location information to the wagering game server 250 in order to configure avatars of wagering games with location-based customization options. Furthermore, the wagering game unit 264 can generate game results based on random numbers received from the wagering game server 250, or may communicate with the wagering game server 250 to obtain the game results. The content store 266 is configured to store content that is presented on the wagering game machine 260. The presentation unit 268 is configured to control the presentation of the game content on the wagering game machine 260. The presentation unit 268 can include one or more browsers and any other software and/or hardware suitable for presenting audio and video content. It is noted, however, that in other implementations the game content can be presented using other display technologies.

The gaming machines described herein (e.g., gaming machines 260) can take any suitable form, such as floor standing models, handheld mobile units, bar-top models, workstation-type console models, surface computing machines, etc. Further, gaming machines can be primarily dedicated for use in conducting wagering games, or can include non-dedicated devices, such as personal computers (PC), mobile phones, personal digital assistants (PDAs), laptop computers, etc. For example, the non-dedicated devices can provide players access to wagering games via a wireless network within a physical casino, or remotely via the Internet.

In some embodiments, each of the gaming machines 260 and the wagering game server 250 are configured to work together such that the gaming machine 260 can be operated as a thin, thick, or intermediate client. For example, one or more elements of game play may be controlled by the gaming machine 260 (client) or the wagering game server 250 (server). Game play elements can include executable game code, lookup tables, configuration files, game results, audio or visual representations of the game, game assets or the like. In a thin-client example, the wagering game server 250 can perform functions such as determining game results or managing assets, while the gaming machine 260 can present a audible/graphical representation of such outcome or asset modification to the players. In a thick-client example, the gaming machine 260 can determine game outcomes and communicate the outcomes to the wagering game server 250 for recording or managing a player's account.

In some embodiments, either the wagering game machines (client) or the wagering game server(s) can provide functionality that is not directly related to game play. For example, account transactions and account rules may be managed centrally (e.g., by the wagering game server(s)) or locally (e.g., by the wagering game machines). Other functionality not directly related to game play may include power management, presentation of advertising, software or firmware updates, system quality or security checks, etc.

Each component shown in the wagering game system architecture 200 is shown as a separate and distinct element connected via a communications network 255. However, some functions performed by one component could be performed by other components. For example, the wagering game server 250 can be configured to perform some or all of the functions of the account server 270, and/or the game management unit 252 can be configured to perform some or all of the functions of the game customization unit 256. Furthermore, the components shown may all be contained in one device, but some, or all, may be included in, or performed by multiple devices, as in the configurations shown in FIG. 2 or other configurations not shown, e.g., the game customization unit can be distributed across the wagering game server 250 and the gaming machines 260. Furthermore, the wagering game system architecture 200 can be implemented as software, hardware, any combination thereof, or other forms of embodiments not listed. For example, any of the network components (e.g., the wagering game tables, machines, servers, etc.) can include hardware and machine-readable media including instructions for performing the operations described herein. Machine-readable media includes any mechanism that provides (i.e., stores and/or transmits) information in a form readable by a machine (e.g., a wagering game table, machine, computer, etc.). For example, tangible machine-readable media storage includes read only memory (ROM), random access memory (RAM), magnetic disk storage media, optical storage media, flash memory machines, and other types of tangible storage medium suitable for storing instructions. Machine-readable transmission media also includes any media suitable for transmitting software over a network.

Although FIG. 2 describes some embodiments, the following sections describe many other features and embodiments.

### Example Operations

This section describes operations associated with some embodiments. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable storage media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

FIG. 3 is a flow diagram (“flow”) 300 illustrating operations for implementing location-based customization of avatars associated with wagering games in a wagering game system, according to some embodiments. The flow of 300 will be described with reference to the example system architecture of FIG. 2. The flow diagram begins at block 302.

At block 302, the wagering game server 250 configures a wagering game initiated at a first gaming location with a first set of customization options, associated with the first gaming location, for an avatar associated with the wagering game. In one example, the wagering game initiated for a first player can be a slots wagering game including one or more secondary games (e.g., bonus games, side games, etc.). In some embodiments, the wagering game server 250 (e.g., the game customization unit 256 of FIG. 2) can configure the wagering game with the location-based customization options (e.g., the first set of customization options) by configuring various game play elements associated with the wagering games; for example, configuring game play elements, such as executable game code, lookup tables, configuration files, audio or visual representations of the game, game assets, or the like. In one example, the wagering game server 250 can configure the wagering game such that the wagering game elements, environment, and game interface displayed to the first player exhibits the theme specified by the configuration options associated with the particular gaming location. The wagering game server 250 can configure the wagering game such that the accessories and supplementary items available for further customizing the avatar exhibit the theme and other characteristics (e.g., special powers, enhancements, use restrictions, etc.) specified by the associated customization options. For example, this may configure the accessories and supplementary items that are found within the wagering game, that are earned by playing the wagering game, and/or that are included in an avatar customization menu or window (e.g., a “build your avatar” or “customize your avatar” window) to be consistent with the specifications of the associated customization options. It is noted, however, that the wagering game server 250 may configure other aspects of the wagering game to be consistent with the customization options for the avatar; e.g., the wagering game server 250 can configure video and audio presentations of the avatar that will be displayed during celebrations of a win (or other game events) to be consistent with the theme and other characteristics specified by the customization options. After block 302, the flow continues at block 304.

At block 304, the wagering game server 250 (e.g., the game customization unit 256) can detect whether the avatar associated with the wagering game is customized according to one or more customization options from the first set of customization options associated with the first gaming location. For example, the wagering game server 250 can detect when the first player earns one or more avatar accessories or supplementary items based on the player's performance in the wagering game. In another example, the wagering game server 250 can detect when the first player uses game credits that the player has earned during game play (e.g., in a bonus game) to select (or “purchase”) one or more avatar accessories or supplementary items. At block 305, if the wagering game server 250 detects that the avatar has been customized according to one or more customization options, the flow continues at block 306. Otherwise, the flow loops back to the beginning of block 304.

At block 306, the wagering game server 250 (e.g., the game customization unit 256) determines whether the one or more customization options from the first set of customization options have special attributes or other game related benefits. For example, the wagering game server 250 can determine whether one of the customization options that was earned and/or selected to customize the avatar has a location-based use restriction. The benefit of the customization option for the avatar that has a location-based use restriction may only be gained when the player plays the wagering game at one or more specified gaming locations. For example, the special powers, enhanced abilities, or increased earning potential that are associated with a customization option having the location-based use restriction may only be utilized at the one or more specified locations. For instance, referring back to the dragon avatar example, the player may earn a pair of wings for the dragon avatar at a first physical casino that has a location-based use restriction specifying that the pair of wings can only benefit the avatar when the player plays the wagering game via at a particular online casino. In this example, the location-based use restrictions can be used by a casino operator to drive player traffic to another casino (e.g., a sister casino property), and/or to encourage continued play of the wagering game when the player returns home (e.g., via an online casino). In another example, the wagering game server 250 can randomly or non-randomly provided additional benefits to certain customization options for the avatar at some gaming locations. Therefore, the wagering game server 250 may determine whether the customization options earned or selected by the player for the avatar currently offer the player additional benefits. For instance, in the dragon avatar example, a particular type of tail for the dragon may currently offer the player additional earnings potential in a bonus game played at a specific physical casino. In some cases, for promotional purposes, if the player is playing the wagering game at a particular gaming location, e.g., the Las Vegas Luxor casino, the wagering game server 250 may provide additional benefits to avatar accessories that bear the Luxor name, e.g., a Luxor t-shirt for the dragon avatar. In some examples, the wagering game server 250 can determine whether the customization options earned or selected at a first gaming location can combine with other customization options previously earned or selected at another gaming location to provide the player additional benefits with respect to the avatar and the wagering game, as will be further described below at block 318 of FIG. 4. After block 306, the flow continues at block 308.

At block 308, the wagering game server 250 (e.g., the game management unit 252 of FIG. 2) determines whether the player ends the wagering game session at the first gaming location. For example, the wagering game server 250 determines results associated with the wagering game at the first gaming location, and detects player input indicating the player wants to ends the wagering game session. If the player ends the wagering game session, the flow continues at block 310. Otherwise, the flow loops back to the beginning of block 304.

At block 310, the wagering game server 250 stores the customized avatar for the player. For example, the wagering game server 250 (e.g., the game customization unit 256) can store the avatar and all the customization options the player earned and/or selected during the wagering game session at the first gaming location. In one example, the wagering game server 250 can store the avatar within the player's wagering game system account; e.g., the wagering game server 250 can store the avatar and provide a link to the avatar via the player's wagering game system account. In some embodiment, the player can access the stored avatar in the future from any gaming location when the player wants to play the wagering game. For example, as will be further described below, the player can go home from the physical casino, access the stored avatar, and continue playing the wagering game online. In some embodiments, the player may also access the stored avatar (e.g., via the player's wagering game system account) to further customize the avatar. For example, the player can access a “customize your avatar” window or menu, and customize the avatar (e.g., using available game credits), or change the customization of the avatar (e.g., change the type of wings of the dragon avatar). After block 310, the flow continues at block 312.

At block 312, the wagering game server 250 (e.g., the game management unit 252) determines whether the player initiates the wagering game associated with the avatar at another gaming location. If the player initiates the wagering game at another gaming location, the flow continues at block 314 of FIG. 4. Otherwise, the flow loops back to the beginning of block 312.

FIG. 4 is a flow diagram illustrating additional operations for implementing location-based customization of avatars associated with wagering games in a wagering game system, according to some embodiments. The flow shown in FIG. 4 is a continuation of the flow 300 shown in FIG. 3. The flow diagram begins at block 314.

At block 314, after a wagering game session for the wagering game associated with the avatar (e.g., the customized avatar stored for the first player) is initiated at a second gaming location for the first player, the wagering game server 250 configures the wagering game with a second set of customization options, associated with the second gaming location, for the avatar associated with the wagering game. For example, the wagering game server 250 (e.g., the game customization unit 256) can configure the wagering game with the second set of customization options similarly as described above with reference to block 302. The second set of customization options for the avatar (associated with the second gaming location), may be different than the first set of customization options for the avatar (associated with the first gaming location). After block 314, the flow continues at block 316.

At block 316, the wagering game server 250 (e.g., the game customization unit 256) can detect when the avatar associated with the wagering game is customized according to one or more customization options from the second set of customization options associated with the second gaming location. For example, the wagering game server 250 can detect when the player earns one or more avatar accessories or supplementary items based on the player's performance in the wagering game at the second gaming location. In another example, the wagering game server 250 can detect when the player uses game credits that the player has earned during game play (e.g., in a bonus game) to select (or “purchase”) one or more avatar accessories or supplementary items at the second gaming location. After block 316, the flow continues at block 318.

At block 318, the wagering game server 250 (e.g., the game customization unit 256) can determine whether the customization options earned or selected at the second gaming location can combine with the customization options previously earned or selected at the first gaming location to provide the player additional benefits with respect to the avatar and the wagering game. For example, if the wagering game server 250 detects certain combination of customization options from multiple gaming locations, the wagering game server 250 can configure the wagering game, or enable certain features in the wagering game, to provide the avatar special powers, enhanced abilities, increased earnings potential, etc. for the player, and/or various other game-related benefits. For instance, in the dragon avatar example, if the wagering game server 250 detects the orange dragon wings associated with the first gaming location and the orange dragon tail associated with the second gaming location, the wagering game server 250 can configure the wagering game to give the dragon enhanced flying speed in a bonus game, and/or configure the wagering game to give the player a multiplier in either the base wagering game or a bonus game for increased earning potential. After block 318, the flow continues at block 320.

At block 320, the wagering game server 250 (e.g., the game management unit 252) determines whether the player ends the wagering game session at the second gaming location. For example, the wagering game server 250 determines results associated with the wagering game at the second gaming location, and detects player input indicating the player wants to ends the wagering game session. If the player ends the wagering game session, the flow continues at block 322. Otherwise, the flow loops back to the beginning of block 316.

At block 322, the wagering game server 250 stores the customized avatar for the player. For example, the wagering game server 250 (e.g., the game customization unit 256) can store the avatar and all the customization options the player earned and/or selected during the wagering game session at the second gaming location (in addition to customization options previously stored from the first gaming location). For example, the wagering game server 250 can store the customized avatar similarly as described above with reference to block 310 of FIG. 3 to be available for future access and game play. After block 322, the flow loops back to the beginning of block 312 of FIG. 3, where the wagering game server 250 determines whether the player initiates the wagering game associated with the avatar at another gaming location.

FIG. 5 is a flow diagram (“flow”) 500 illustrating operations for implementing location-based customization of avatars associated with wagering games for community gaming applications, according to some embodiments. The flow of 500 will be described with reference to the example system architecture of FIG. 2. The flow diagram begins at block 502.

At block 502, the wagering game server 250 (e.g., the game management unit 252) detects that a wagering game session for a wagering game is initiated at a first gaming location for a first player, and a wagering game session for the same wagering game is initiated at a second gaming location for a second player. For example, a slots wagering game associated with a dragon avatar is initiated at a first physical casino for the first player, and the same slots wagering game associated with the dragon avatar is initiated at a second physical casino for the second player. As described above, the wagering game server 250 can configure the wagering game for the first player with a first set of customization options, associated with the first gaming location, for the avatar of the first player, and configure the wagering game for the second player with a second set of customization options, associated with the second gaming location, for the avatar of the second player. After block 502, the flow continues at block 504.

At block 504, the wagering game server 250 (e.g., the game customization unit 256) determines that the first player playing the wagering game at the first location and the second player playing the wagering game at the second location are friends in a virtual gaming community associated with the wagering game system 200. In one embodiment, the wagering game server 250 can determine that both the first and second players are members of a virtual gaming community (e.g., the virtual gaming community implemented by the community server 280 described above in FIG. 2). Additionally, the wagering game server 250 can determine whether a wagering game account of the first player is associated with a wagering game account of the second player in the virtual gaming community. For example, the wagering game server 250 can determine whether the wagering game account of the first player is tied or linked to the wagering game account of the second player. In one example, the wagering game account 250 can determine that both the first and second players have indicated that they are friends in their virtual gaming community account or website profile (e.g., by adding the other person to their “friends list”). In one example, the wagering game server 250 can search each of the player's “friends list” to determine whether both the first player and the second player have indicated that they are friends in the virtual gaming community. After block 504, the flow continues at block 506.

At block 506, the wagering game server 250 (e.g., the game customization unit 256) determines whether to provide additional location-based customization options (for the avatars associated with the wagering game) to the first and second players. In one embodiment, the wagering game server 250 can provide one or more bonus location-based customization options for the avatars associated with the first and second players if the players are friends and are playing the wagering game contemporaneously at different locations. For example, the wagering game server 250 can instantly offer the players a bonus customization option (e.g., an avatar accessory, such as a t-shirt) that increases the earning potential of the avatars in the base wagering game and corresponding bonus games. It is noted, however, that the wagering game server 250 can offer a bonus customization option to the players that provides other game-related benefits, e.g., gives the avatar new or enhanced game-related powers or skills to perform better in the wagering game. Furthermore, in some embodiments, the wagering game server 250 can determine whether the customization options that the player has earned and/or selected for the avatar can combine with the customization options that the second player has earned and/or selected for the avatar to provide additional customization options. For instance, in the dragon avatar example, the wagering game server 250 may determine whether the blue sword accessory earned by the first player at the first gaming location for the dragon avatar can combine with the blue shield dragon avatar accessory earned by the second player at the second gaming location to provide both dragon avatars a blue armor dragon avatar accessory that offers both dragon avatars special fighting moves during a bonus game. In some embodiments, the wagering game server 250 can allow both the first player and the second player to send alerts or other notifications (e.g., via text, email, etc.) to other friends in the virtual gaming community asking them to play the wagering game. In some embodiments, the more friends in the virtual gaming community that are playing the wagering game contemporaneously, the more customization options and other game-related benefits the group of players can receive during game play. For example, the larger the group of friends that play the wagering game at different locations, the more customization options that can combine to provide each player in the group additional avatar customization options and game-related benefits.

At block 508, the wagering game server 250 (e.g., the game management unit 252) determines whether either player ends the wagering game session. If both the first and second players continue the wagering game sessions, the flow continues at block 510. Otherwise, the flow ends.

At block 510, the wagering game server 250 (e.g., the game customization unit 256) determines whether the first player or the second player earns or selects additional customization options during game player. In some embodiments, during game play, either one of the players can earn or select customization options for the corresponding avatar that when combined with the customization options of the other avatar can provide the players additional customization options and game-related benefits, as was described above in block 506. If either player earns or selects additional customization options, the flow loops back to the beginning of block 506, where the wagering game server 250 determines whether to provide additional location-based customization options and benefits to the players. Otherwise, the flow loops back to the beginning of block 508.

It is noted, however, that in some embodiments, the wagering game server 250 may provide the same benefits if the first player and the second player are members of the virtual gaming community, even if they are not considered “friends”. In other embodiments, the wagering game server 250 can provide the same benefits if the first player and the second player have indicated they are friends in one or more social networking websites.

It is noted, however, that location-based customization of avatar in wagering game can be implemented for various other game applications. In one example, if various location-based customization options obtained a different locations can be combined, or otherwise detected on an avatar, to provide a game-related benefit, the wagering game server 250 can inform players of the benefits that each combination of customization options can provide to the player. For instance, in the dragon avatar example, the wagering game server 250 can specify that the player will win a special customization option (e.g., dragon super flying speed, or a multiplier for the base game, or 20 free spins) if the player earns the gold pair of dragon wings from a first casino, the gold dragon tail from a second casino, the gold dragon armor from a third casino, and the gold dragon breath from a fourth casino. In another example, the wagering game server 250 can randomly determine the combinations that provide the players additional game-related benefits, and therefore randomly award players for their customized avatars.

In one example, the more the player builds up his avatar by earning various customization options at a first gaming location, the better the avatar performs in the wagering game at a second gaming location. For example, a first player can customize a first avatar with various location-based customization options associated with the first gaming location while the first player plays the base wagering game. The first player can then issue a challenge where the first avatar of the first player (e.g., customized at the first gaming location) can compete, in a secondary game associated with the base game, with a second avatar of a second player (e.g., customized at a second gaming location). In one example, the first player can issue a challenge to the player's friends in a virtual gaming community. In another example, the first player can issue a challenge to any member of the virtual gaming community (e.g., all members of the virtual gaming community that have opted in to participate in this type of game). After the first player issues the challenge to the second player, the wagering game server 250 detects the challenge between the first avatar of the first player and the second avatar of the second player in the secondary game. In one embodiment, the wagering game server 250 (e.g., the game customization unit 256) determines the number of customization options associated with the first avatar and the second avatar. The avatar with the greatest number of customization options wins the challenge. In one embodiment, the wagering game server 250 detects the number and type of customization option associated with the first avatar and the second avatar. Each customization option is associated with a predefined number of points. The wagering game server 250 determines the points associated with the customization options of the first avatar, and the points associated with the customization options of the second avatar. The avatar with the greatest number of points wins the challenge. In one embodiment, in addition to the point calculating described above, the wagering game server 250 can also use a random number generator to generate a random element for each avatar that can be combined with the point total to determine which avatar wins the challenge. For instance, in the dragon avatar example, the first player can build up the first dragon avatar with customization options at the MGM Grand casino, and the second player can build the second dragon avatar with customization options at the Luxor casino. For example, the first player can use the first dragon avatar built up at the MGM Grand casino to challenge the second player's avatar at a different gaming location, e.g., at the Luxor casino. In one example, the first player can strategically build up certain parts of the dragon avatar prior to the challenge to try to win the challenge. For example, the first player may play the base wagering game to try to earn certain dragon avatar accessories that may “strengthen” the dragon (i.e., provide more points); e.g., the first player may try to earn superior dragon wings, dragon tails, dragon armor, dragon weapons, etc. In some embodiments, wagering game server 250 can also use the random number generator to randomly determine the type of battle or contest the avatars participate in during the challenge. For instance, in the dragon avatar example, the random number generator can randomly determine the setting of the battle between two dragon avatars, the fight sequence, the special powers and fight moves that the dragon avatar use during the fight, etc. In some embodiments, the wagering game server 250 can detect when the players play additional rounds of the base wagering game during the challenge between the two avatars in the secondary game. The wagering game server 250 can automatically update the avatars with additional or bonus customization options based on the number of rounds of the base wagering game the player plays during the challenge and/or the performance of the player during the base wagering game. For example, if the first player continuously plays the base wagering game and places max bets in each round, the wagering game server 250 can provide the player one or more bonus customization options for the first dragon avatar that can help the dragon avatar in the challenge. This can encourage the players to continue playing the base wagering game during the challenge between the avatars in the secondary game. In some embodiments, similar to the head-to-head challenge between two avatars described above, a first group of players can use their avatars to challenge the avatars of a second group of players. For example, a first group of players having dragon avatars built up at the MGM grand casino can challenge a second group of players having dragon avatars at the Luxor casino. In another embodiment, a player or a group of players can challenge another player or group of players across wagering game themes. For example, the first group of players having dragon avatars at the MGM Grand casino can challenge a second group of players having pirate avatars at the Treasure Island casino.

In another example, the wagering game server 250 can determine the number of players from a virtual gaming community that are playing a wagering game from different gaming locations. In this example, the wagering game server 250 can provide all of the members of the virtual gaming community that are contemporaneously playing the wagering game additional or bonus customization options for the avatars associated with the wagering games.

### Additional Example Operating Environments

This section describes example operating environments, systems and networks, and presents structural aspects of some embodiments.

### Wagering Game Machine Architecture

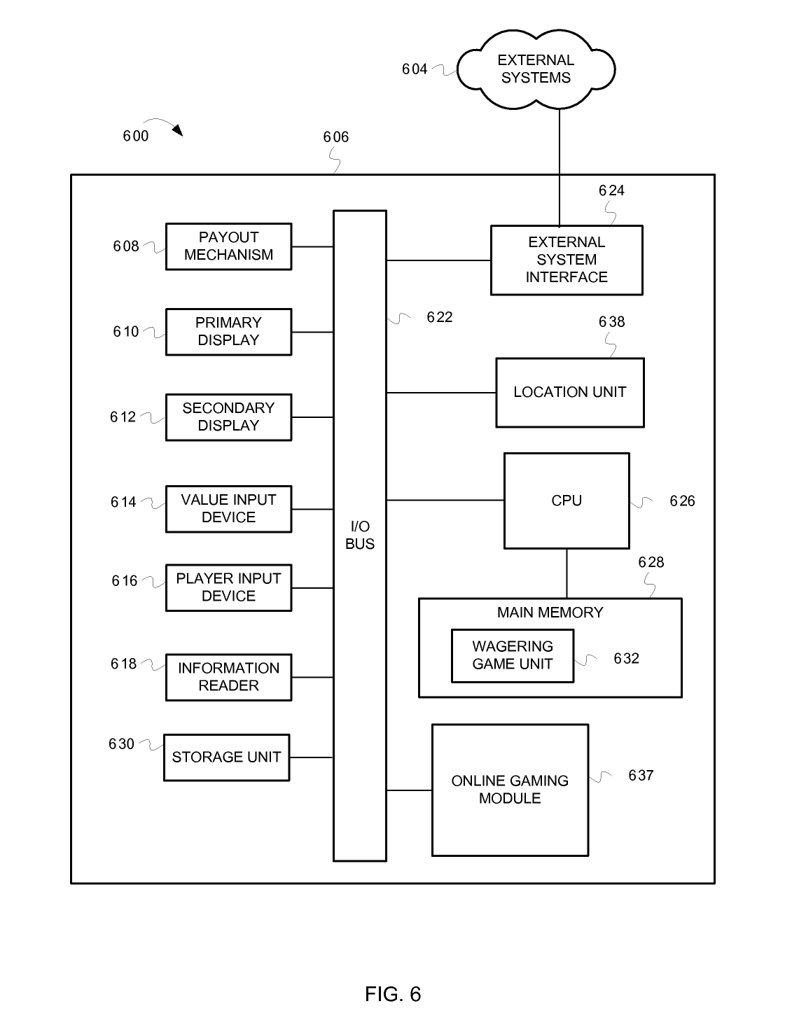

FIG. 6 is a conceptual diagram that illustrates an example of a wagering game machine architecture 600, according to some embodiments. In FIG. 6, the wagering game machine architecture 600 includes a wagering game machine 606, which includes a central processing unit (CPU) 626 connected to main memory 628. The CPU 626 can include any suitable processor, such as an Intel® Pentium processor, Intel® Core 2 Duo processor, AMD Opteron™ processor, or UltraSPARC processor. The main memory 628 includes a wagering game unit 632. In some embodiments, the wagering game unit 632 can present wagering games, such as video poker, video black jack, video slots, video lottery, reel slots, etc., in whole or part. The wagering game unit 632 may also facilitate location-based customization of avatars in a wagering game system, e.g., as described above with reference to FIGS. 1-5.

The CPU 626 is also connected to an input/output (“I/O”) bus 622, which can include any suitable bus technologies, such as an AGTL+ frontside bus and a PCI backside bus. The I/O bus 622 is connected to a payout mechanism 608, primary display 610, secondary display 612, value input device 614, player input device 616, information reader 618, and storage unit 630. The player input device 616 can include the value input device 614 to the extent the player input device 616 is used to place wagers. The I/O bus 622 is also connected to an external system interface 624, which is connected to external systems 604 (e.g., wagering game networks). The external system interface 624 can include logic for exchanging information over wired and wireless networks (e.g., 802.11g transceiver, Bluetooth transceiver, Ethernet transceiver, etc.)

The I/O bus 622 is also connected to a location unit 638. The location unit 638 can create player information that indicates the wagering game machine's location/movements in a casino. In some embodiments, the location unit 638 includes a global positioning system (GPS) receiver that can determine the wagering game machine's location using GPS satellites. In other embodiments, the location unit 638 can include a radio frequency identification (RFID) tag that can determine the wagering game machine's location using RFID readers positioned throughout a casino. Some embodiments can use GPS receiver and RFID tags in combination, while other embodiments can use other suitable methods for determining the wagering game machine's location. Although not shown in FIG. 6, in some embodiments, the location unit 638 is not connected to the I/O bus 622.

In some embodiments, the wagering game machine 606 can include additional peripheral devices and/or more than one of each component shown in FIG. 6. For example, in some embodiments, the wagering game machine 606 can include multiple external system interfaces 624 and/or multiple CPUs 626. In some embodiments, any of the components can be integrated or subdivided.

In some embodiments, the wagering game machine 606 includes an online gaming module 637. The online gaming module 637 can process communications, commands, or other information, where the processing can control and present online wagering games. In some embodiments, the online gaming module 637 can work in concert with the wagering game unit 632, and can perform any of the operations described above.

Furthermore, any component of the wagering game machine 606 can include hardware, firmware, and/or machine-readable storage media including instructions for performing the operations described herein.

### Example Wagering Game Machines

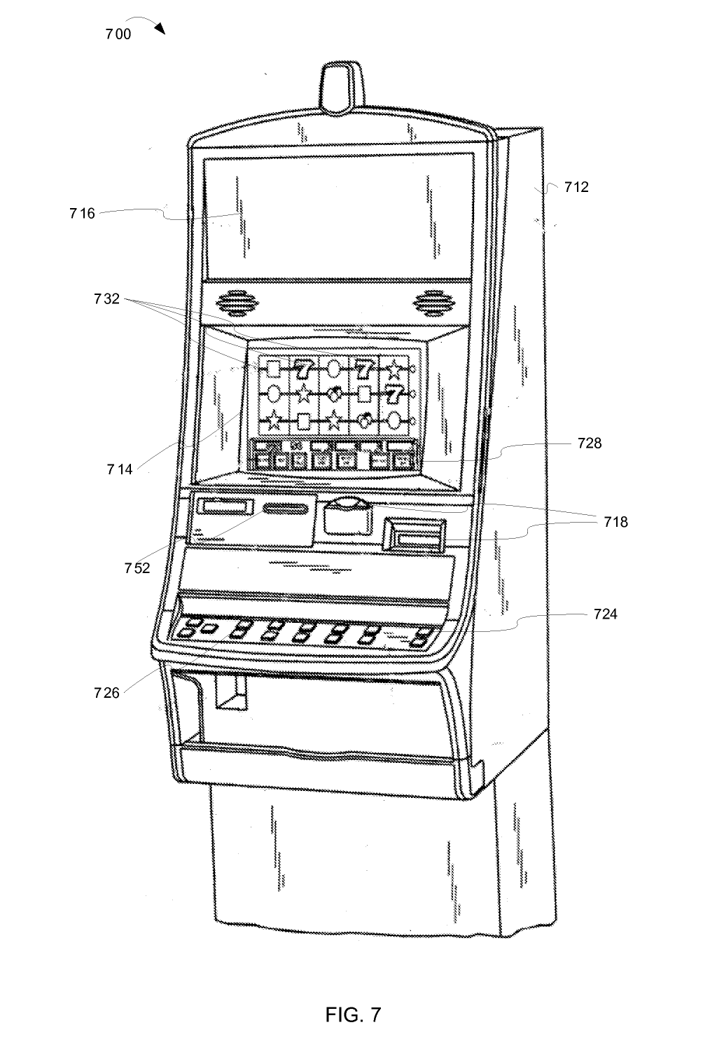

FIG. 7 is a perspective view of a wagering game machine, according to example embodiments. Referring to FIG. 7, a wagering game machine 700 is used in gaming establishments, such as casinos. In some embodiments, the wagering game machine 700 can implement the functionality described above in FIGS. 1-6 for implementing location-based customization of avatars in wagering game systems.

According to embodiments, the wagering game machine 700 can be any type of wagering game machine and can have varying structures and methods of operation. For example, the wagering game machine 700 can be an electromechanical wagering game machine configured to play mechanical slots, or it can be an electronic wagering game machine configured to play video casino games, such as blackjack, slots, keno, poker, blackjack, roulette, etc.

The wagering game machine 700 comprises a housing 712 and includes input devices, including value input devices 718 and a player input device 724. For output, the wagering game machine 700 includes a primary display 714 for displaying information about a basic wagering game. In some implementations, the primary display 714 can also display information about a bonus wagering game and a progressive wagering game. The wagering game machine 700 also includes a secondary display 716 for displaying bonus wagering games, wagering game events, wagering game outcomes, and/or signage information. While some components of the wagering game machine 700 are described herein, numerous other elements can exist and can be used in any number or combination to create varying forms of the wagering game machine 700.

The value input devices 718 can take any suitable form and can be located on the front of the housing 712. The value input devices 718 can receive currency and/or credits inserted by a player. The value input devices 718 can include coin acceptors for receiving coin currency and bill acceptors for receiving paper currency. Furthermore, the value input devices 718 can include ticket readers or barcode scanners for reading information stored on vouchers, cards, or other tangible portable storage devices. The vouchers or cards can authorize access to central accounts, which can transfer money to the wagering game machine 700.

The player input device 724 comprises a plurality of push buttons on a button panel 726 for operating the wagering game machine 700. In addition, or alternatively, the player input device 724 can comprise a touch screen 728 mounted over the primary display 714 and/or secondary display 716.

The various components of the wagering game machine 700 can be connected directly to, or contained within, the housing 712. Alternatively, some of the wagering game machine's components can be located outside of the housing 712, while being communicatively coupled with the wagering game machine 700 using any suitable wired or wireless communication technology.

The operation of the basic wagering game can be displayed to the player on the primary display 714. The primary display 714 can also display a bonus game associated with the basic wagering game. The primary display 714 can include a cathode ray tube (CRT), a high resolution liquid crystal display (LCD), a plasma display, light emitting diodes (LEDs), or any other type of display suitable for use in the wagering game machine 700. Alternatively, the primary display 714 can include a number of mechanical reels to display the outcome. In FIG. 7, the wagering game machine 700 is an “upright” version in which the primary display 714 is oriented vertically relative to the player. Alternatively, the wagering game machine can be a “slant-top” version in which the primary display 714 is slanted at about a thirty-degree angle toward the player of the wagering game machine 700. In yet another embodiment, the wagering game machine 700 can exhibit any suitable form factor, such as a free standing model, bartop model, mobile handheld model, or workstation console model.

A player begins playing a basic wagering game by making a wager via the value input device 718. The player can initiate play by using the player input device's buttons or touch screen 728. The basic game can include arranging a plurality of symbols along a payline 732, which indicates one or more outcomes of the basic game. Such outcomes can be randomly selected in response to player input. At least one of the outcomes, which can include any variation or combination of symbols, can trigger a bonus game.

In some embodiments, the wagering game machine 700 can also include an information reader 752, which can include a card reader, ticket reader, bar code scanner, RFID transceiver, or computer readable storage medium interface. In some embodiments, the information reader 752 can be used to award complimentary services, restore game assets, track player habits, etc.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A computer-implemented method comprising:
determining, by a wagering game server, that a wagering game session for a wagering game is initiated at a first gaming location, wherein the wagering game comprises an avatar that is customizable according to a plurality of location-based customization options;
configuring, by the wagering game server, the wagering game with a first set of customization options, associated with the first gaming location, for the avatar of the wagering game to be played on a first gaming machine associated with the first gaming location;
determining, by the wagering game server, that a wagering game session for the wagering game is initiated at a second gaming location; and
configuring, by the wagering game server, the wagering game with a second set of customization options, associated with the second gaming location, for the avatar of the wagering game to be played on a second gaming machine associated with the second gaming location, wherein the second set of customization options is different than the first set of customization options.

2. The computer-implemented method of claim 1, further comprising:
in response to determining that the wagering game session for the wagering game is initiated at the first gaming location for a first player account:
causing the wagering game configured with the first set of customization options to be presented on the first gaming machine associated with the first gaming location for the first player account;
determining when the avatar associated with the wagering game is customized, during the wagering game session, according to a first customization options from the first set of customization options associated with the first gaming location; and
storing the avatar customized according to the first customization option from the first set of customization options.

3. The computer-implemented method of claim 2, further comprising:
in response to determining that the wagering game session for the wagering game is initiated at the second gaming location for the first player account:
causing the avatar customized according to the first customization option from the first set of customization options and the wagering game configured with the second set of customization options to be presented on the second gaming machine associated with the second gaming location for the first player account;
determining when the avatar is customized, during the wagering game session, according to a second customization option from the second set of customization options associated with the second gaming location; and
configuring the wagering game with a bonus customization option for the avatar in response to determining that the avatar is customized by a combination of the first customization option from the first set of customization options and the second customization option from the second set of customization options.

4. The computer-implemented method of claim 3, further comprising:
determining that the first customization option from the first set of customization options, associated with the first gaming location, for the avatar comprises a location-based use restriction specifying that the first customization option can only be used at the second gaming location;
in response to determining that the wagering game session for the wagering game is initiated at the second gaming location for the first player account, enabling the first customization option from the first set of customization options for the avatar to be used during the wagering game session for the wagering game initiated at the second gaming location.

5. The computer-implemented method of claim 3, further comprising storing the avatar customized according to the first customization option from the first set of customization options and the second customization option from the second set of customization options.

6. The computer-implemented method of claim 1, further comprising:
determining results of the wagering game associated with the first gaming location, and causing the first gaming machine associated with the first gaming location to present the results; and
determining results of the wagering game associated with the second gaming location, and causing the second gaming machine associated with the second gaming location to present the results.

7. The computer-implemented method of claim 1, wherein the plurality of location-based customization options comprises one or more of a plurality of themes for the avatar, a plurality of accessories for the avatar, a plurality of themes for the accessories for the avatar, a plurality of attribute associated with a subset of the plurality of accessories for the avatar, and a plurality of game-related benefits associated with a subset of the plurality of accessories for the avatars.

8. The computer-implemented method of claim 1, wherein said configuring the wagering game with a first set of customization options associated with the first gaming location comprises configuring the wagering game such that the location-based customization options available to customize the avatar when a player plays the wagering game at the first gaming location include the first set of customization options, and said configuring the wagering game with a second set of customization options associated with the second gaming location comprises configuring the wagering game such that the location-based customization options available to customize the avatar when the player plays the wagering game at the second gaming location include the second set of customization options.

9. The computer-implemented method of claim 1, wherein the first gaming location is a physical casino and the second gaming location is an online casino.

10. The computer-implemented method of claim 1, wherein the first gaming location is a first physical casino and the second gaming location is a second physical casino.

11. The computer-implemented method of claim 1, wherein the first gaming machine is a dedicated wagering game machine at a physical casino, and the second gaming machine is a non-dedicated gaming machine at a location outside of a physical casino.

12. The computer-implemented method of claim 1, wherein the wagering game comprises a base wagering game and one or more secondary wagering games.

13. A wagering game server comprising:
a game management unit operable to determine that a wagering game session for a wagering game is initiated at a first gaming location associated with a wagering game system, and determine that a wagering game session for the wagering game is initiated at a second gaming location associated with the wagering game system, wherein the wagering game comprises an avatar that is customizable according to a plurality of location-based customization options; and
a game customization unit operable to configure the wagering game initiated at the first gaming location with a first set of customization options, associated with the first gaming location, for the avatar, and operable to configure the wagering game initiated at the second gaming location with a second set of customization options, associated with the second gaming location, for the avatar, wherein the second set of customization options is different than the first set of customization options.

14. The wagering game server of claim 13, in response to the game management unit determining that the wagering game session for the wagering game is initiated at the first gaming location for a first player account, further comprising:
the game management unit operable to cause the wagering game configured with the first set of customization options to be presented on a first gaming machine associated with the first gaming location for the first player account; and
the game customization unit operable to:
determine when the avatar associated with the wagering game is customized, during the wagering game session, according to a first customization options from the first set of customization options associated with the first gaming location; and
store the avatar customized according to the first customization option from the first set of customization options.

15. The wagering game server of claim 14, in response to the game management unit determining that the wagering game session for the wagering game is initiated at the second gaming location for the first player account, further comprising:
the game management unit operable to cause the avatar customized according to the first customization option from the first set of customization options and the wagering game configured with the second set of customization options to be presented on the second gaming machine associated with the second gaming location for the first player account; and
the game customization unit operable to:
determine when the avatar is customized, during the wagering game session, according to a second customization option from the second set of customization options associated with the second gaming location; and
configure the wagering game with a bonus customization option for the avatar in response to determining that the avatar is customized by a combination of the first customization option from the first set of customization options and the second customization option from the second set of customization options.

16. A computer-implemented method comprising:
determining, by a wagering game server, that a wagering game is being played at a first gaming location associated with a wagering game system, wherein the wagering game being played at the first gaming location is associated with a first player account and comprises an avatar that is customizable according to a first set of customization options associated with the first gaming location;
determining, by the wagering game server, that the wagering game is being played at a second gaming location associated the wagering game system contemporaneously to the wagering game being played at the first gaming location, wherein the wagering game being played at the second gaming location is associated with a second player account and comprises an avatar that is customizable according to a second set of customization options associated with the second gaming location, wherein the second set of customization options is different than the first set of customization options;
determining, by the wagering game server, that the first player account is associated with the second player account in a virtual gaming community associated with the wagering game system; and
in response to determining that the first player account is associated with the second player account:
configuring, by the wagering game server, the wagering game being played at the first gaming location with one or more bonus customization options for the avatar associated with the first player account; and
configuring, by the wagering game server, the wagering game being played at the second gaming location with the one or more bonus customization options for the avatar associated with the second player account.

17. The computer-implemented method of claim 16, wherein said determining that the first player account is associated with the second player account in the virtual gaming community comprises determining that the first player account is linked with the second player account in the virtual gaming community.

18. The computer-implemented method of claim 16, wherein said determining that the first player account is associated with the second player account in the virtual gaming community comprises detecting an indication in the first player account associated with a first player that a second player associated with the second player account is a friend of the first player in the virtual gaming community and detecting an indication in the second player account that the first player is a friend of the second player in the virtual gaming community.

19. The computer-implemented method of claim 16, further comprising:
determining results of the wagering game associated with the first gaming location, and causing a first gaming machine associated with the first gaming location to present the results; and
determining results of the wagering game associated with the second gaming location, and causing a second gaming machine associated with the second gaming location to present the results.

20. A wagering game server comprising:
means for determining that a wagering game is being played at a first gaming location associated with a wagering game system, wherein the wagering game being played at the first gaming location is associated with a first player account and comprises an avatar that is customizable according to a first set of customization options associated with the first gaming location;
means for determining that the wagering game is being played at a second gaming location associated the wagering game system contemporaneously to the wagering game being played at the first gaming location, wherein the wagering game being played at the second gaming location is associated with a second player account and comprises an avatar that is customizable according to a second set of customization options associated with the second gaming location, wherein the second set of customization options is different than the first set of customization options;
means for determining that the first player account is associated with the second player account in a virtual gaming community associated with the wagering game system; and
in response to determining that the first player account is associated with the second player account:
means for configuring the wagering game being played at the first gaming location with one or more bonus customization options for the avatar associated with the first player account; and
means for configuring the wagering game being played at the second gaming location with the one or more bonus customization options for the avatar associated with the second player account.

21. The wagering game server of claim 20, wherein said means for determining that the first player account is associated with the second player account in the virtual gaming community comprises means for determining that the first player account is linked with the second player account in the virtual gaming community.

22. The wagering game server of claim 20, further comprising:
means for determining results of the wagering game associated with the first gaming location, and causing a first gaming machine associated with the first gaming location to present the results; and
means for determining results of the wagering game associated with the second gaming location, and causing a second gaming machine associated with the second gaming location to present the results.

23. One or more machine-readable storage media, having instructions stored therein, which, when executed by one or more processors causes the one or more processors to perform operations that comprise:
determining that a wagering game session for a wagering game is initiated at a first gaming location, wherein the wagering game comprises an avatar that is customizable according to a plurality of location-based customization options;
configuring the wagering game with a first set of customization options, associated with the first gaming location, for the avatar of the wagering game to be played on a first gaming machine associated with the first gaming location;
determining that a wagering game session for the wagering game is initiated at a second gaming location; and
configuring the wagering game with a second set of customization options, associated with the second gaming location, for the avatar of the wagering game to be played on a second gaming machine associated with the second gaming location, wherein the second set of customization options is different than the first set of customization options.

24. The machine-readable storage media of claim 23, wherein said operations further comprise:
in response to determining that the wagering game session for the wagering game is initiated at the first gaming location for a first player account:
causing the wagering game configured with the first set of customization options to be presented on the first gaming machine associated with the first gaming location for the first player account;
determining when the avatar associated with the wagering game is customized, during the wagering game session, according to a first customization options from the first set of customization options associated with the first gaming location;
storing the avatar customized according to the first customization option from the first set of customization options; and
in response to determining that the wagering game session for the wagering game is initiated at the second gaming location for the first player account:
causing the avatar customized according to the first customization option from the first set of customization options and the wagering game configured with the second set of customization options to be presented on the second gaming machine associated with the second gaming location for the first player account;
determining when the avatar is customized, during the wagering game session, according to a second customization option from the second set of customization options associated with the second gaming location;
configuring the wagering game with a bonus customization option for the avatar in response to determining that the avatar is customized by a combination of the first customization option from the first set of customization options and the second customization option from the second set of customization options.

25. The machine-readable storage media of claim 23, wherein said operations further comprise:
determining results of the wagering game associated with the first gaming location, and causing the first gaming machine associated with the first gaming location to present the results; and
determining results of the wagering game associated with the second gaming location, and causing the second gaming machine associated with the second gaming location to present the results.
